(19) United States
(12) Patent Application Publication
(10) Pub. No.: US 2005/0036775 A1
(43) Pub. Date: Feb. 17, 2005

(54) Position detection apparatus, optical apparatus, image-taking system, position detection method and program

(75) Inventor: Yosuke Morimoto, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/909,322

(22) Filed: Aug. 3, 2004

(30) Foreign Application Priority Data
Aug. 8, 2003 (JP) 2003-290975

(51) Int. Cl. G03B 7/00

(52) U.S. Cl. 396/67; 396/80; 396/87

(57) ABSTRACT

A position detection apparatus capable of carrying out position detection according to temperature variations is disclosed. The position detection apparatus comprises a first detection sensor which generates a plurality of detection signals according to movement of an object, a conversion section which generates a converted signal by subjecting at least one detection signal out of the detection signals to conversion processing using a conversion data obtained from the detection signal on, a calculation section which calculates a position of the object based on the converted signal and a second detection sensor which detects a temperature.

### BACKGROUND OF THE INVENTION

1. Field of the Invention

The present invention relates to a position detection apparatus, position detection method, program for detecting the position of an object such as an optical element which is movable for focusing of an optical system, and an optical apparatus and image-taking system.

2. Description of the Related Art

A conventional position detection apparatus having a position detection element (magnetic resistor element (MR element)), which outputs a sine-wave signal according as an object moves, selects a phase including a signal component having excellent linearity from a plurality of signal output from the position detection element, performs a calculation involving interpolation of the signal component and thereby detects the position of the object. The following is an explanation of a case where an MR element is used as the position detection element.

As shown in FIG. 9, the signals with a plurality of phases output from the MR element generally have different amplitudes and different levels of amplitude centers. When these output signals are used to detect the position of the object, sufficient accuracy of position detection is not obtained, and therefore a gain and an offset are adjusted so as to make amplitudes and amplitude centers uniform respectively as shown in FIG. 10.

Here, the gain and offset of the output of the MR element fluctuate due to assembly errors of sensors in individual products, errors in electric characteristics of circuits and temperature variations of sensors in normal operation. To keep high the accuracy of position detection of the object, it is necessary to adjust the gain and offset appropriately according to the above described conditions.

As a method of making this adjustment, Japanese Patent No. 3173531 proposes the following method. That is, a lens serving as the object is moved by one wavelength or more of sine-wave output of an MR sensor, a maximum value and a minimum value of the sensor output introduced from an A/D converter are stored in a storage circuit such as a semiconductor memory and adjustment data of the gain and offset are determined by using the stored values. The gain and offset are adjusted by processing the sensor output data introduced from the A/D converter using the adjustment data so as to make amplitudes and center of amplitudes uniform respectively.

More specifically, when the maximum value of the stored sensor output is represented MAX and minimum value is represented MIN, the gain (GAIN) and offset (OFFSET) serving as the adjustment data are calculated from the following Expression (1) and Expression (2). Here, RANGE represents a dynamic range of a data being adjustment.

$$\begin{matrix}GAIN = \frac{RANGE}{MAX - MIN} & [ Expression 1 ] \\ OFFSET = \frac{MAX + MIN}{2} & [ Expression 2 ]\end{matrix}$$

An output (OUTPUT) with the gain and offset adjusted can be obtained by applying GAIN, OFFSET obtained from the Expressions (1) and (2) and the sensor output (MR) to a correction expression of Expression (3).
OUTPUT=(MR−OFFSET)×GAIN [Expression 3]

Then, by updating the above described adjustment data every time the lens moves by one wavelength or more of the sine-wave output of the MR sensors it is possible to always detect the accurate position even when the ambient temperature changes during the MR sensor is in operation.

However, in the above described conventional technology, the adjustment data (GAIN, OFFSET) is not updated when the lens remains within one wavelength range of the sine-wave output of the MR sensor for a long time. If the ambient temperature changes drastically in the meantime, the maximum value and minimum value of the MR sensor output vary according to the ambient temperature.

More specifically, the MR sensor output in a temperature environment of, for example, −5° C. is a sine-wave signal shown by a thick solid line in FIG. 11, while the MR sensor output in a temperature environment of 25° C. is a sine-wave signal shown by a dotted line in FIG. 11. Then, the maximum values and minimum values of the sensor output at −5° C. and 25° C. are MAX1, MIN1 and MAX2, MIN2, respectively.

Here, when the lens moves in the direction indicated by an arrow in FIG. 11 to position P in the temperature environment of −5° C., MAX1 is stored as the maximum value. Then, while the lens remains at position P, even if the ambient temperature changes from −5° C. to 25° C., the maximum value remains MAX1 which is the value before the ambient temperature changes because the lens has not moved.

When the lens further moves to position Q in FIG. 11, MIN2 after the ambient temperature changes to 25° C. is stored as the minimum value and it is decided that the lens has moved by one wavelength or more of the sensor output and the adjustment data (GAIN, OFFSET) is updated according to Expression (1) and Expression (2).

However, MAX1 before the ambient temperature changes (at −5° C.) and MIN2 after the ambient temperature changes (at 25° C.) are used as MAX and MIN in Expressions (1) and (2). This results in a problem that correct adjustment data corresponding to the temperature variation cannot be obtained and the accuracy of position detection deteriorates.

### SUMMARY OF THE INVENTION

It is an object of the present invention to repress the above described inappropriate gain/offset adjustments form being performed in a case where the temperature in a position detection apparatus changes while an object moves, and thereby suppress deterioration of the accuracy of position detection.

One aspect of a position detection apparatus according to the present invention comprises a first detection sensor which generates a plurality of detection signals according to movement of an object, a conversion section which generates a converted signal by subjecting at least one detection signal of the detection signals to a conversion processing using a conversion data obtained from the one detection signal, a calculation section which calculates a position of the object based on the converted signal and a second detection sensor which detects a temperature. Here, for a first detection signal of the detection signals, the conversion section carries out the conversion processing based on the first detection signal and for a second detection signal, the conversion section prohibits the conversion processing based on the second detection signal. The second detection signal is a detection signal generated by the first detection sensor in a case where a difference between a temperature detected by the second detection sensor at a first timing and a temperature detected later at a second timing is greater than a predetermined value.

One aspect of an optical apparatus of the present invention comprises an optical system and the above described position detection apparatus which detects a position of at least one optical element in the optical system.

One aspect of an image-taking system of the present invention comprises a lens apparatus having a movable optical element and an image-taking apparatus on which the lens apparatus is mounted. This image-taking system comprises a first detection sensor which generates a plurality of detection signals according to movement of the optical element, a conversion section which generates a converted signal by subjecting at least one detection signal of the detection signals to a conversion processing using a conversion data obtained from the one detection signal, a calculation section which calculates a position of the optical element based on the converted signal and a second detection sensor which detects a temperature. Here, for a first detection signal of the detection signals, the conversion section carries out the conversion processing based on the first detection signal and for a second detection signal, the conversion section prohibits the conversion processing based on the second detection signal. The second detection signal is a detection signal generated by the first detection sensor in a case where a difference between a temperature detected by the second detection sensor at a first timing and a temperature detected later at a second timing is greater than a predetermined value.

One aspect of a position detection method of the present invention comprises a first step of generating a plurality of detection signals according to movement of an object, a second step of generating a converted signal by subjecting at least one detection signal of the detection signals to a conversion processing using a conversion data obtained from the one detection signal, a third step of calculating the position of the object based on the converted signal and a fourth step of detecting a temperature. Here, in the second step, for a first detection signal of the detection signals, the conversion processing based on the first detection signal is carried out, and for a second detection signal, the conversion processing based on the second detection signal is prohibited. The second detection signal is a detection signal generated in the first step in a case where a difference between a temperature detected in the fourth step at a first timing and a temperature detected later at a second timing is greater than a predetermined value.

The features of the position detection apparatus, optical apparatus, image-taking system and position detection method of the invention will become more apparent from the following detailed description of a preferred embodiment of the invention with reference to the drawings.

### BRIEF DESCRIPTION OF THE DRAWINGS

FIG. 1 shows a structure of a camera according to Embodiment 1;

FIG. 2 is a flow chart showing gain/offset adjustment processing according to Embodiment 1;

FIG. 3 shows a linear variation characteristic of the amplitude of an MR sensor output with respect to temperature;

FIG. 4 shows a linear variation characteristic of the amplitude center of the MR sensor output with respect to temperature;

FIG. 5 is a flow chart showing gain/offset adjustment processing according to Embodiment 2;

FIG. 6 shows a curved variation characteristic of the amplitude of the MR sensor output with respect to temperature;

FIG. 7 shows a curved variation characteristic of the amplitude center of MR sensor output with respect to temperature;

FIG. 8 shows a structure of a camera according to Embodiment 3;

FIG. 9 shows a state of the MR sensor output with unadjusted gain and offset;

FIG. 10 shows a state of the MR sensor output with adjusted gain and offset; and

FIG. 11 shows variations in maximum values and minimum values of the MR sensor output due to variations in ambient temperature.

### DETAILED DESCRIPTION OF THE PREFERRED EMBODIMENTS

[Embodiment 1]

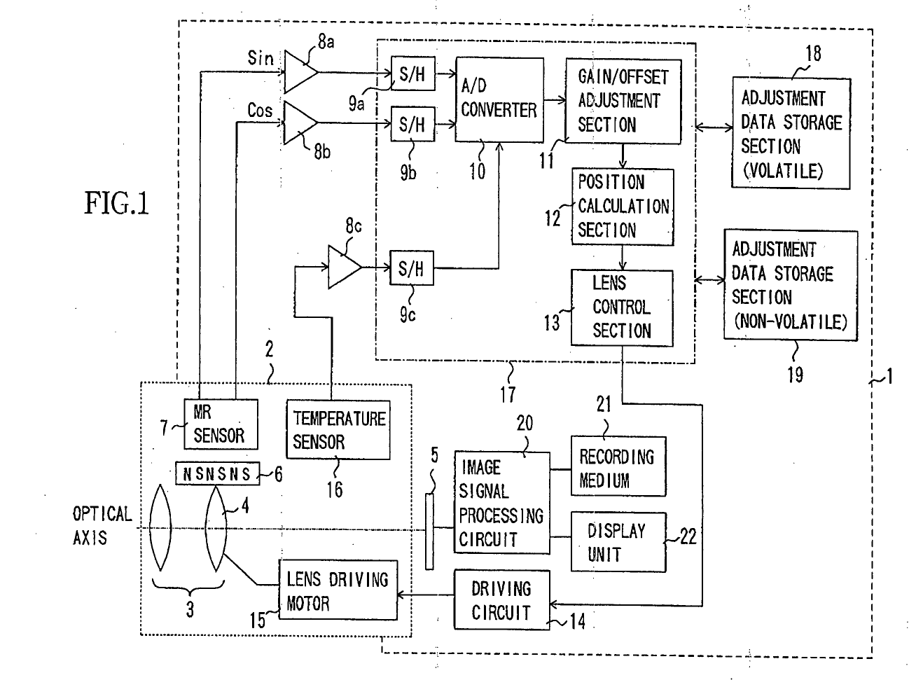

FIG. 1 is a block diagram showing a structure of a camera (optical apparatus) provided with a position detection apparatus according to Embodiment 1 of the present invention.

In FIG. 1, reference numeral 1 denotes a camera, 2 denotes a lens barrel mounted on the camera 1. This and subsequent embodiments will describe a lens-integral type camera, but the present invention is also applicable to a camera system having a camera body and a lens apparatus attached to the camera body in a detachable manner.

Reference numeral 3 denotes an image-taking optical system provided in the lens barrel 2. Reference numeral 4 denotes a focusing lens (object) included in the image-taking optical system 3, which can move in the direction of the optical axis (lateral direction in FIG. 1) by receiving a driving force of a lens driving motor 15 through a power transmission mechanism (not shown).

Reference numeral 5 denotes an image pickup device such as a CCD or CMOS, which receives an object image (optical image) formed by the imago-taking optical system 3 and converts the image to an electric signal (image data) and outputs it. This output image data is subjected to image processing (color processing and gamma correction, etc.) by an image signal processing circuit 20 and can be recorded in a recording medium 21 made up of a magnetic tape, optical disk, semiconductor memory, etc. Furthermore, the output of the image signal processing circuit 20 is input to the display unit 22 made up of an LCD, etc., and can be displayed on a display unit 22 as an image taken.

This embodiment describes a digital camera having the image pickup device, but the present invention is also applicable to a camera using a film.

A detection magnet (first detection sensor) 6 is placed in such a way as to move together with the focusing lens 4 ink the direction of the optical axis and is magnetized to alternating opposite polarities along the moving direction. An MR sensor (first detection sensor) 7 is fixed to the lens barrel 2 (fixed in the moving direction of the focusing lens 4) so as to face the detection magnet 6 with a predetermined gap and outputs signals with two phases of sine and cosine waves according to variations in the magnetic field caused by the movement of the detection magnet 6 in conjunction with the focusing lens 4.

As described above, this embodiment uses the detection magnet 6 which is a periodically magnetized magnet member as the first detection sensor and the MR sensor 7 which is a magnetic detector moving relative to the magnet member according to the movement of the object (focusing lens 4) and outputs position detection signals with a plurality of phases according to a magnetic variation caused by the movement. Here, the first detection sensor (MR sensor 7) having the above described structure outputs signals with a plurality of phases which vary periodically according to variations in the position of the object.

In this embodiment, the outputs of the MR sensor 7 have two phases of sine and cosine waves, but the present invention is not limited to this and may also have outputs with three or more phases.

In the above described explanation, the MR sensor 7 is fixed to the lens barrel 2 and the detection magnet 6 moves in conjunction with the focusing lens 4, but it is also possible to adopt such a structure that the detection magnet 6 is fixed to the lens barrel 2 and the MR sensor 7 moves in conjunction with the focusing lens 4.

The output of the MR sensor 7 is amplified by amplifiers 8a, 8b, passed through sample-and-hold circuits 9a, 9b, and converted to digital signals by an A/D converter 10. For the MR sensor output loaded in this way, its gain and offset are adjusted by a gain/offset adjustment section (conversion section) 11 and then the position of the focusing lens 4 is calculated by a position calculation section (calculation section) 12.

Here, the gain/offset adjustment section 11 as the conversion section creates gain and offset values as conversion data based on maximum value data and minimum value data obtained from the sensor output signal while the object moves by a distance corresponding to one wavelength of the sensor output, as will be described later, and adjusts the gain and offset of the sensor output signal (performs predetermined conversion processing) based on the gain and offset values.

The lens position data obtained by the position calculation section 12 is sent to a lens control section 13 and used for servo control of the lens position

The lens control section 13 gives a drive signal to a drive circuit 14, drives a lens driving motor 15 and can thereby control the position of the focusing lens 4. The focusing lens 4 is controlled through auto focusing control (e.g., control by a publicly known phase difference detection method or contrast detection method) so that the focusing lens 4 moves to a position where the image-taking optical system is in an in-focus state.

An adjustment data storage section 18 is made up of a volatile semiconductor storage element such as a DRAM and stores adjustment data such as the gain and offset of the MR sensor output and maximum value and minimum value of sine-wave output. The gain/offset adjustment section 11 reads the adjustment data from the adjustment data storage section 18 and adjusts the gain and offset of the MR sensor output according to Expression (3) above.

An adjustment data storage section 19 is made up of a non-volatile semiconductor storage element such as ROM and EEPROM and stores fixed data such as a threshold of an amount of temperature variation which will be described later.

Furthermore, the lens barrel 2 is provided with a temperature sensor (second detection sensor) 16 for measuring temperature near the MR sensor 7. The output signal of the temperature sensor 16 is passed through an amplifier 8c, a sample-and-hold circuit 9c and converted to a digital signal by the A/D converter 10. Here, the temperature sensor 16 can also be used as a correction temperature sensor used to correct defocusing due to temperature. That is, since the in-focus position of the focusing lens 4 in the direction of the optical axis may vary according to the ambient temperature, it is possible to correct the in-focus position of the focusing lens 4 by detecting the ambient temperature. Providing the one sensor 16 with two functions can reduce the size and cost of the camera 1 compared to a camera provided with two sensors having their respective functions.

The components in the area enclosed by a single-dot dashed line in FIG. 1 are constructed as hardware or software in a camera CPU 17 which performs various types of control on operations of the camera 1. However, the present invention is not limited to this, but can also be adapted so that the sample-and-hold circuits 9a, 9b and 9c, and the A/D converter 10 are provided outside the camera CPU 17 or the adjustment data storage sections 18 and 19 are incorporated in the camera CPU 17.

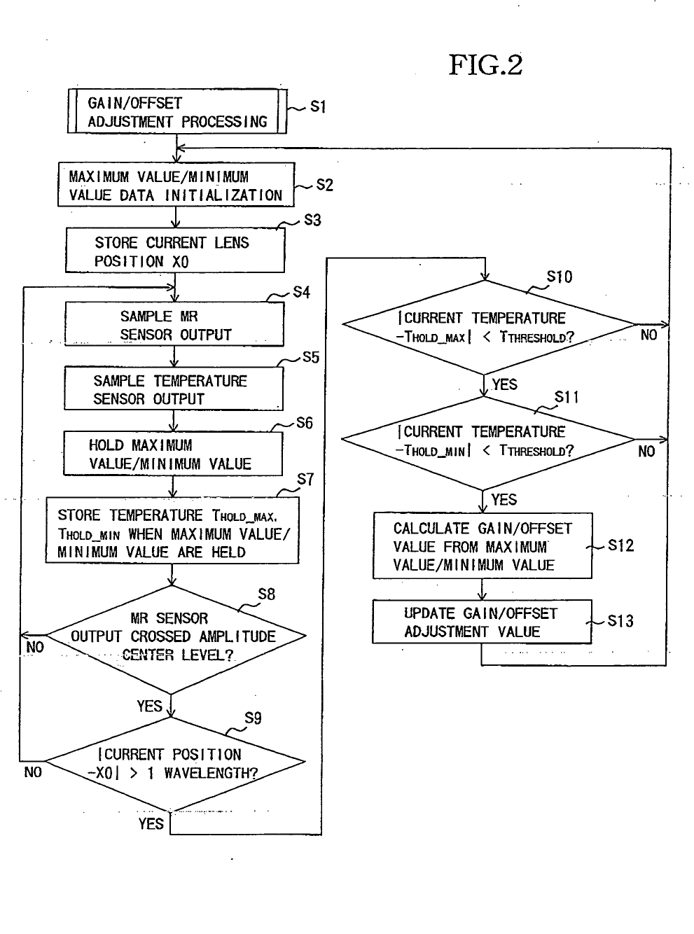

Then, the gain/offset adjustment processing of the MR sensor output will be explained according to the flow chart shown in FIG. 2. The following processing will be carried out on signals with a plurality of phases output from the MR sensor 7, respectively.

First, in step S2, the maximum value and minimum value data of the MR sensor output are initialized. More specifically, the minimum value of the output data of the A/D converter 10 is set as the maximum value data and the maximum value of the output data of the A/D converter 10 is set as the minimum value data and these values are stored in the adjustment data storage section 18.

Then, in step S3, the current position data X0 of the focusing lens 4 is stored in the adjustment data storage section 18. This position data is used to decide in step S9 later whether the focusing lens 4 has moved a distance corresponding to one wavelength or more of MR sensor output or not.

Then in step S4, the output of the MR sensor 7 is sampled and further in step S5, the output of the temperature sensor 16 is sampled.

Further, in step S6, the processing of holding the maximum value and minimum value of the MR sensor output is carried out. More specifically, the maximum value and minimum value data stored in the adjustment data storage section 18 is compared with the A/D conversion value of the MR sensor output. Then, when the A/D conversion value of the MR sensor output is greater than the prestored maximum value data, this A/D conversion value is used as the maximum value data and when the A/D conversion value is smaller than the prestored minimum value data, this A/D conversion value is used as the minimum value data to thereby update the adjustment data (maximum value data or minimum value data). Otherwise, the maximum value and minimum value data are not updated.

In this way, the maximum value and minimum value data of the MR sensor output is stored in the adjustment data storage section 18. In addition, in step S7, the adjustment data storage section 18 stores temperature T_{HOLD}_{_{—}}_{MAX} when the maximum value data is updated (one of the first timing and second timing) and temperature T_{HOLD}_{_{—}}_{MIN} when the minimum value data is updated (the other of the first timing and second timing).

In step S8, it is determined whether the MR sensor output has crossed the amplitude center level or not. Since the sine-wave signal output from the MR sensor 7 crosses the amplitude center level every half wavelength, the determination in step S8 allows the amount of movement of the focusing lens 4 to be detected in a half-wavelength cycle. As specific processing, the determination of the crossing is made based on whether the sign of the MR sensor output data which is gain/offset-adjusted according to Expression (3) has changed from positive to negative, or from negative to positive.

Here, when the amplitude center level is not crossed, the focusing lens 4 has not moved by a half wavelength yet, and therefore the process returns to step S4. On the other hand, when it is determined that the amplitude center level is crossed, the process advances to step S9.

In step S9, it is determined whether the absolute value (distance of movement of the focusing lens 4) of the difference between lens position X0 stored in step S3 and the current lens position after movement is equal to or greater than the distance corresponding to one wavelength of the MR sensor output or not. In the aforementioned determination in step S8, it is not possible to determine whether the focusing lens 4 has moved by a half wavelength or one wavelength or returned to the position of the last crossing. Therefore, in step S9, it is determined whether the amount of movement of the focusing lens 4 corresponds to one wavelength or not.

Here, if the focusing lens 4 has not moved by one wavelength, the process returns to step S4. On the other hand, when it is determined that the focusing lens 4 has moved by one wavelength, the process advances to step S10.

In step S10, the current temperature (temperature when adjustment data is created) is detected based on the output of the temperature sensor 16 and it is determined whether the absolute value of the difference between the detected temperature and temperature T_{HOLD}_{_{—}}_{MAX} corresponding to the maximum value data stored in step S7 is smaller than predetermined threshold T_{THRESHOLD} or not. This threshold T_{THRESHOLD} indicates the temperature difference in which the shift of the MR sensor output is allowable in adjusting the gain and offset of the MR sensor output and is stored in the non-volatile adjustment data storage section 19.

Here, if the temperature difference is greater than threshold T_{THRESHOLD}, the currently held maximum value data of the MR sensor output is not appropriate for gain/offset adjustment due to temperature variations. In this case, adjustment data of gain and offset is not updated and the process returns to step S2 and the maximum value and minimum value data are initialized again. On the other hand, if the temperature difference is smaller than threshold T_{THRESHOLD}, the currently held maximum value data is appropriate for gain/offset adjustment, and therefore the process advances to step S11.

In step S11, as with step S10, it is determined whether the absolute value of the difference between the current temperature (temperature when adjustment data is created) detected by the temperature sensor 16 and temperature T_{HOLD}_{_{—}}_{MIN} corresponding to the minimum value data stored in step S7 is smaller than the predetermined threshold T_{THRESHOLD} or not.

Here, if the temperature difference is greater than threshold T_{THRESHOLD}, the currently held minimum value data of the MR sensor output is not appropriate for gain/offset adjustment due to temperature variations. In this case, the process returns to step S2 without updating adjustment data of gain and offset, and then the maximum value and minimum value data are initialized again. On the other hand, if the temperature difference is smaller than threshold T_{THRESHOLD}, the currently held minimum value data is appropriate for gain/offset adjustment, and therefore the process advances to step S12.

In step S12, based on the maximum value and minimum value data stored in the adjustment data storage section 18, the adjustment data is calculated according to Expression (1) and Expression (2), and the adjustment data (GAIN, OFFSET) of the adjustment data storage section 18 is updated in step S13.

According to the aforementioned flow chart, in the case where a large temperature variation exceeding threshold T_{THRESHOLD} occurs during the focusing lens 4 moves a distance corresponding to one wavelength of the MR sensor output, the gain/offset adjustment processing based on the MR sensor output (second detection signal) obtained in this case is prohibited. That is, by prohibiting the updating of the adjustment data of gain and offset calculated from the maximum value and minimum value data of the MR sensor output, it is possible to prevent gain/offset adjustment processing which is inappropriate for position detection.

On the other hand, in the case where the temperature variation does not exceed threshold T_{THRESHOLD}, gain/offset adjustment processing is carried out based on the MR sensor output (first detection signal) obtained in this case. That is, the adjustment data of the gain and offset is determined from the maximum value and minimum value data of the MR sensor output, and then gain/offset adjustment processing of the MR sensor output is performed based on the adjustment data.

[Embodiment 2]

Then, a camera (optical apparatus) provided with a position detection apparatus which is Embodiment 2 of the present invention will be explained. The structure of the camera in this embodiment is the same as the structure of the camera explained in Embodiment 1 and same components are assigned the same reference numerals and explanations thereof will be omitted Hereinafter, parts different from those of Embodiment 1 will be explained.

In this embodiment, the non-volatile adjustment data storage section 19 prestores a data concerning coefficient of variation of gain and offset of the MR sensor output with respect to a temperature variation, and when the adjustment data of the gain and offset is not updated, the adjustment data of the gain and offset is corrected based on the temperature variation and the data of coefficient of variation. Then, gain/offset adjustment processing is carried out based on the corrected adjustment data.

Hereinafter, the processing of adjusting gain and offset variations of the MR sensor output with respect to variations in ambient temperature will be explained. Here, since the contents of adjustment processing of the gain and offset are substantially common, the gain adjustment processing will be explained below and explanations of the offset adjustment processing will be omitted except parts specific thereto.

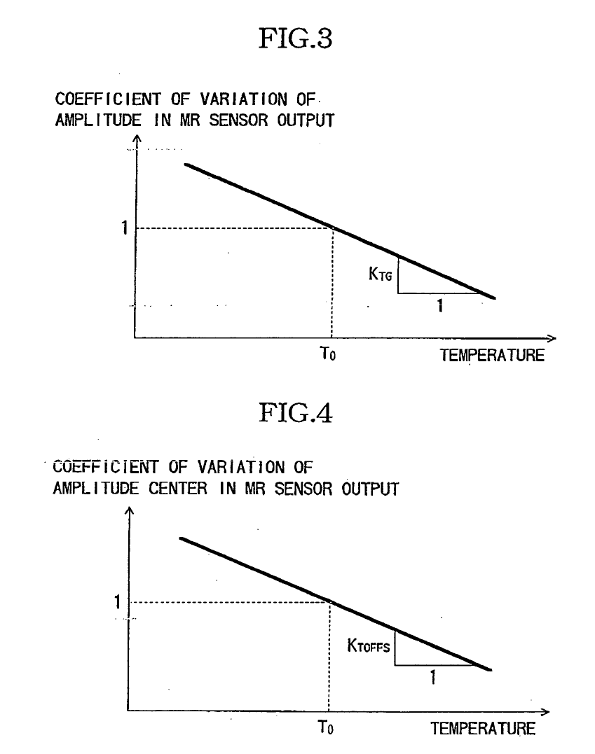

First, the gain adjustment processing when the amplitude and amplitude center of the output of the MR sensor 7 are approximately assumed to change linearly depending on the temperature variation as shown in FIGS. 3 and 4 will be explained.

First, a gradient K_{TG} [1/° C.] of coefficient of variation of the amplitude with respect to the temperature when the amplitude at a reference temperature T₀ is assumed to be a reference (coefficient of variation of amplitude is equal to 1) is calculated through a sensor characteristic test as shown in FIG. 3. And the gradient K_{TG} is stored in the non-volatile adjustment data storage section 19.

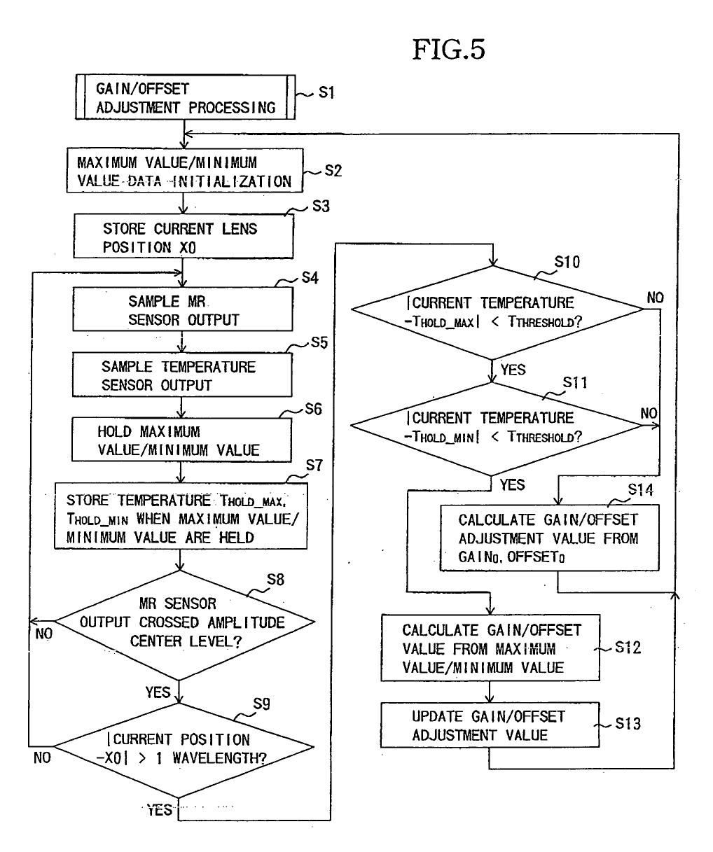

Then, gain adjustment processing is carried out according to the flow chart shown in FIG. 5. Here, in step S1 to step S13, the same processing as that in Embodiment 1 (flow chart in FIG. 2) will be carried out.

Here, in step S12 in which gain adjustment data is calculated, gain adjustment data (GAIN₀) at a reference temperature T₀ is calculated according to Expression (4) below instead of Expression (1) and the calculated gain adjustment data is stored in the adjustment data storage section 18.

In Expression (4), T_{INIT} represents a temperature obtained by sampling the temperature sensor output when GAIN₀ is calculated. Furthermore, MAX and MIN in Expression (4) represent a maximum value and a minimum value of the MR sensor output at temperature T_{INIT}, respectively.

$${GAIN}_{0} = \frac{RANGE}{MAX - MIN} \{ 1 + {K}_{TG} ( {T}_{INIT} - {T}_{0} ) \} \qquad [ Expression 4 ]$$

The temperature correction processing using the gain adjustment data (GAIN₀) will be carried out as follows:

In step S10 or step S11 in FIG. 5, when it is determined that the absolute value of the difference between the current temperature (detection temperature when gain adjustment data is created) detected by the temperature sensor 16 and temperature (T_{HOLD}_{_{—}}_{MAX}, T_{HOLD}_{_{—}}_{MIN}) corresponding to the maximum value data or minimum value data stored in step S7 is greater than a predetermined threshold T_{THRESHOLD}, the process advances to step S14. Here, it is assumed that the detection temperature changes from T_{INT} to T. The absolute value of the difference between T_{INT} and T is greater than the threshold T_{THRESHOLD}.

In step S14, a gain (GAIN) corresponding to a temperature T when adjustment data is created is calculated from the following Expression (5).

$$GAIN = \frac{{GAIN}_{0}}{\{ 1 + {K}_{TG} ( T - {T}_{0} ) \}} \qquad [ Expression 5 ]$$

Then, using the gain adjustment data (GAIN) obtained from Expression (5), the gain/offset adjustment section 11 adjusts the gain. Here, if there is no temperature variation, that is, T=T_{INIT}, Expression (5) becomes equal to Expression (1).

On the other hand, the same processing as for the aforementioned gain adjustment processing will be carried out on the offset adjustment data, too. That is, with regard to the offset adjustment data, offset adjustment data subjected to temperature correction processing is obtained by using the following Expression (6) instead of Expression (4) and the following Expression (7) instead of Expression (5). Then, the offset is adjusted based on the offset adjustment data.

In Expressions (6) and (7), K_{TOFFS} [1/° C.] represents a gradient of coefficient of variation of the amplitude center with respect to temperature when the amplitude center at reference temperature T₀ is assumed to be a reference as shown in FIG. 4. The data of coefficient of variation (K_{TOFFS}) is obtained through a sensor characteristic test and stored in the non-volatile adjustment data storage section 19 in advance. Furthermore, T_{INIT} represents a temperature obtained by sampling the temperature sensor output when acquiring OFFSET₀. Furthermore, MAX, MIN in Expression (6) are the maximum value and minimum value of the MR sensor output at temperature T_{INIT} respectively.

$${OFFSET}_{0} = \frac{MAX + MIN}{2 \{ 1 + {K}_{TOFFS} ( {T}_{INIT} - {T}_{0} ) \}} \qquad [ Expression 6 ]$$

OFFSET=OFFSET₀{1+K_{TOFFS}(T−T₀)} [Expression 7]

Through the above described processing, it is possible to obtain gain/offset adjustment data (conversion data corresponding to a temperature variation equal to or higher than a predetermined value) taking into consideration the temperature variation for an MR sensor output variation due to variations in ambient temperature. And, based on this adjustment data, appropriate gain/offset adjustment processing can be carried out.

So far, the gain/offset adjustment processing assuming that the amplitude and amplitude center of the output of the MR sensor 7 vary linearly depending on the temperature variation has been described.

However, depending on the characteristics of the MR sensor 7 and amplifiers 8a, 8b, it is also possible to assume a case where the amplitude of the MR sensor output changes in a curved form depend on the temperature variation and approximation using a straight line may be insufficient. A method of adjusting the gain in such as case will be explained below.

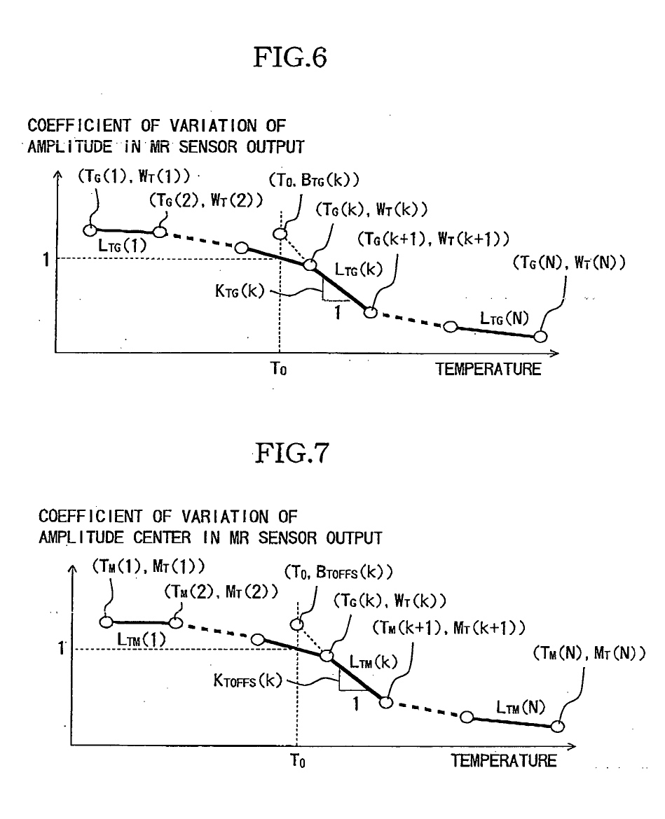

First, assuming that the amplitude at a reference temperature T₀ is a reference, a coefficient of variation of the amplitude with respect to the temperature, that is, graph varying in a curved form is obtained through a sensor characteristic test and the curved variation is approximated using lines L_{TG}(1) to L_{TG}(N) as shown in FIG. 6.

Based on the data of coefficient of variation (lines L_{TG}(1) to L_{TG}(N)) . . . , temperature T_{G}(k) at break points (shown by white bullets in FIG. 6) of the coefficient of variation of the amplitude and data of K_{TG}(k), B_{TG}(k) shown in the following Expressions (8) and (9) for k=1 to N are stored in the non-volatile adjustment data storage section 19.

Here, K_{TG}(k)[1/° C.] represents a gradient of the line L_{TG}(k) and B_{TG}(k) represents an intercept of line L_{TG}(k) when T is equal to T₀. Furthermore, W_{T}(k) represents a coefficient of variation of the amplitude at a break point.

$${K}_{TG} ( k ) = \frac{{W}_{T} ( k + 1 ) - {W}_{T} ( k )}{{T}_{G} ( K + 1 ) - {T}_{G} ( k )} \qquad [ Expression 8 ]$$

B_{TG}(k)=K_{TG}(k){T₀−T_{G}(k)}+W_{T}(k) [Expression 9]

Then, when the gain adjustment data is calculated in step S12 in FIG. 5, the gain (GAIN₀) at the reference temperature T₀ is calculated according to the following Expression (10) instead of Expression (1) and this value is stored in the adjustment data storage section 18. In Expression (10), T_{INIT} represents a temperature obtained by sampling the temperature sensor output when acquiring GAIN₀. K_{TG}(k) and B_{TG}(k) represent gradient and intercept data of line L_{TG}(K) satisfying a following relational Expression.
T_{G}(k)<T_{INIT}<T_{G}(k+1) k=1 to N.

$${GAIN}_{0} = \frac{RANGE}{MAX - MIN} \{ {K}_{TG} ( k ) ( {T}_{INIT} - {T}_{0} ) + {B}_{TG} ( k ) \} \qquad [ Expression 10 ]$$

The temperature correction processing using the adjustment data (GAIN₀) obtained from Expression (10) will be carried out as follows:

In step 310 or step S11 in FIG. 5, the process advances to step S14 when it is determined that the absolute value of the difference between the detection temperature when adjustment data is created and the temperature (T_{HOLD}_{_{—}}_{MAX}, T_{HOLD}_{_{—}}_{MIN}) corresponding to the maximum value data or minimum value data stored in step S7 is greater than a predetermined threshold T_{THRESHOLD}.

In step S14, K_{TG}(k) and B_{TG}(k) corresponding to T_{G}(k)<T<T_{G}(k+1) for k=1 to N are obtained from the adjustment data and the gain (GAIN) corresponding to temperature T when adjustment data is created is calculated from the following Expression (11).

$$GAIN = \frac{{GAIN}_{0}}{\{ {K}_{TG} ( k ) ( T - {T}_{0} ) + {B}_{TG} ( k ) \}} \qquad [ Expression 11 ]$$

Using GAIN obtained in this way, the gain/offset adjustment section 11 carries out gain adjustment processing.

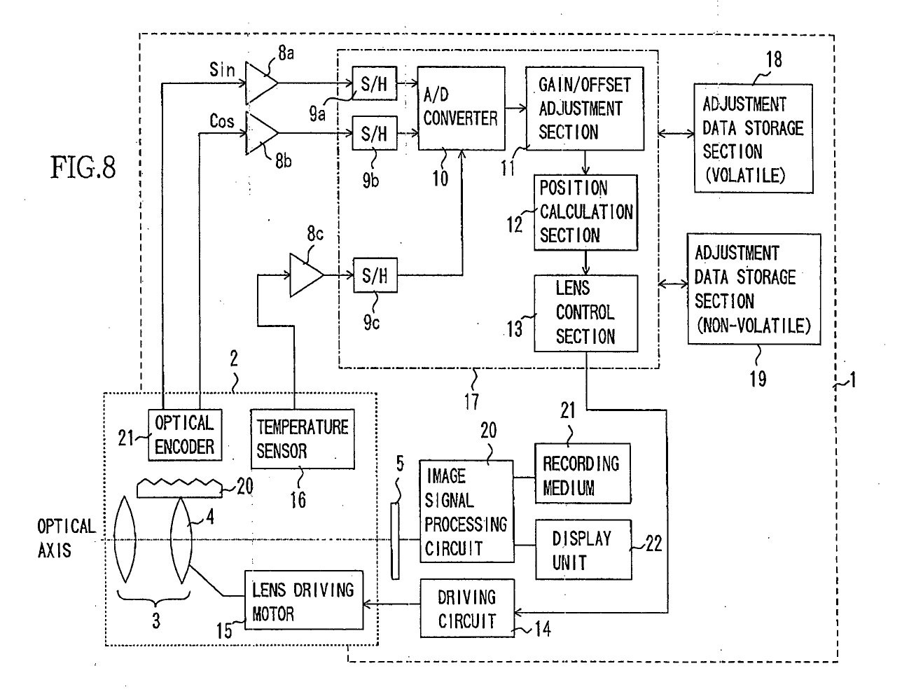

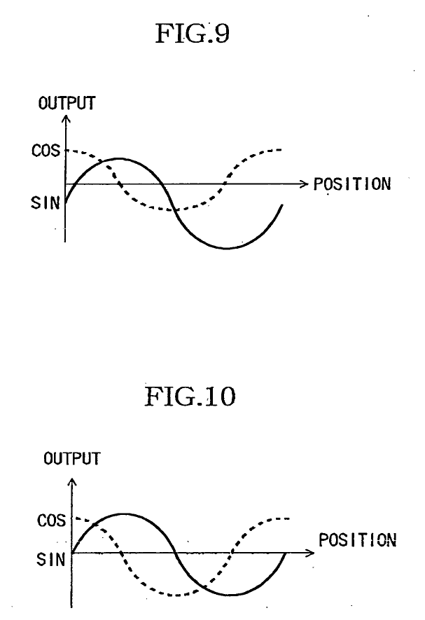

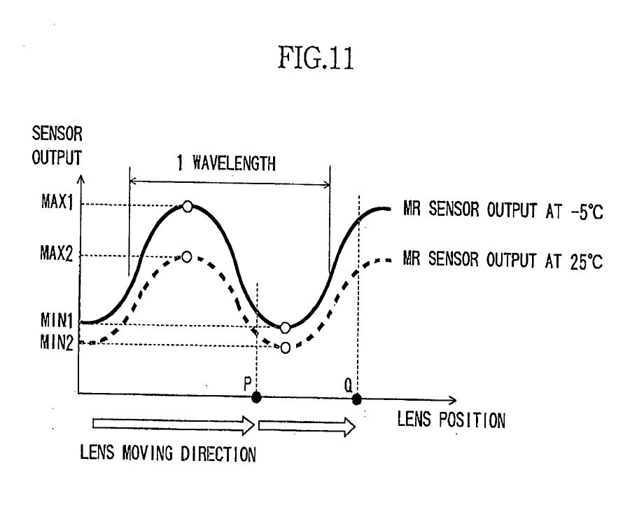

Offset adjustment processing is carried out in substantially the same way as for gain adjustment processing described above. When the amplitude center at reference temperature T₀ is assumed to be a reference, a coefficient of variation of the amplitude center with respect to the temperature (graph varying in a curved form) is determined through a sensor characteristic test in advance. And the curved variation is approximated with lines L_{TM}(1) to L_{TM}(N) as shown in FIG. 7.

Based on the data of coefficient of variation (lines L_{TM}(1) to L_{TM}(N)), temperature T_{M}(k) at break points (shown by white bullets in FIG. 7) of the coefficient of variation of the amplitude center and data of K_{TOFFS}(k) and B_{TOFFS}(k) shown in the following Expressions (12) and (13) for k=1 to N are stored in the non-volatile adjustment data storage section 19.

Here, K_{TOFFS}(k)[1/° C.] represents a gradient of line L_{TM}(k) and B_{TOFFS}(k) represents an intercept of the line L_{TM}(k) when T is equal to T₀. Furthermore, M_{T}(k) represents the coefficient of variation of the amplitude center at a break point.

$${K}_{TOFFS} ( k ) = \frac{{M}_{T} ( k + 1 ) - {M}_{T} ( k )}{{T}_{M} ( K + 1 ) - {T}_{M} ( k )} \qquad [ Expression 12 ]$$

B_{TOFFS}(k)=K_{TOFFS}(k){T₀−T_{M}(k)}+M_{T}(k) [Expression 13]

Then, the offset adjustment processing is carried out by using the following Expression (14) instead of Expression (10) and the following Expression (15) instead of Expression (11).

$${OFFSET}_{0} = \frac{MAX + MIN}{2 \{ {K}_{TOFFS} ( k ) ( {T}_{INIT} - {T}_{0} ) + {B}_{TOFFS} ( k ) \}} \qquad [ Expression 14 ]$$

OFFSET=OFFSET₀{K_{TOFFS}(k)(T−T₀)+B_{TOFFS}(k)} [Expression 15]

Through the above described processing, the MR sensor output due to variations in ambient temperature changes in a curved form and even when an approximation using one straight line is insufficient, it is possible that the appropriate gain and offset adjustment processings corresponding to the curved variation of the MR sensor output (amplitude and amplitude center) are carried out.

As in the case of Embodiment 1, this embodiment prohibits the updating of gain and offset adjustment data, and can thereby repress inappropriate gain/offset adjustment processing due to temperature variations. Moreover, when updating of the adjustment data of gain and offset is prohibited, this embodiment carries out temperature correction processing on adjustment data of the gain and offset using the data of coefficient of variation of the amplitude and amplitude center with respect to the temperature, and can thereby further suppress the deterioration of the accuracy of position detection of the lens compared to Embodiment 1.

[Embodiment 3]

Then, a camera provided with a position detection apparatus according to Embodiment 3 of the present invention will be explained. FIG. 8 is block diagram showing a structure of the camera according to this embodiment. This embodiment differs from Embodiments 1 and 2 in the structure of the position detection apparatus and uses an optical scale 20 and an optical encoder 21 instead of the detection magnet 6 and MR sensor 7 in Embodiments 1 and 2.

That is, as the first detection sensor, this embodiment uses the optical scale 20 serving as an optical scale member which has a reflecting surface whose shape changes periodically and the optical encoder 21 serving as an optical detector which moves relative to the optical scale member as an object (focusing lens 4) moves and outputs position detection signals with a plurality of phases according to the amount of light component out of the projected light, which is reflected on the scale member, received on the optical encoder and varies depending on the movement of the object.

In FIG. 8, the same components as those explained in the foregoing embodiments are assigned the same reference numerals and explanations thereof will be omitted.

The optical encoder 21 has a light-emitting element and a light-receiving element. The optical encoder 21 outputs a signal according to the amount of light component emitted from the light-emitting element, reflected on the optical scale 20 and received on the light-receiving element. The optical scale 20 has a reflecting surface whose shape (orientation) changes periodically in the direction parallel to the optical axis.

Then, according to the shape of the optical scale 20 and through processing on the light signal received from the optical encoder 21, it is possible to create a sine-wave signal similar to that of the MR sensor. Therefore, it is possible to apply the same position detection method and same gain/offset adjustment method as those explained in Embodiments 1 and 2. Specific processing is the same as that described in Embodiments 1 and 2, and therefore explanations thereof will be omitted.

The foregoing embodiments have explained position detection of the focusing lens 4 included in the image-taking optical system of the camera, but the present invention is also applicable to an apparatus which performs position detection operation of a movable optical element (e.g., zoom lens) other than a focusing lens and a movable object other than an optical element.

While preferred embodiments have been described, it is to be understood that modification and variation of the present invention may be made without departing from the scope of the following claims.

This application claims priority from Japanese Patent Application No. 2004-290975 filed on Aug. 8, 2004, which is hereby incorporated by reference herein.

1. A position detection apparatus comprising:
a first detection sensor which generates a plurality of detection signals according to movement of an object;
a conversion section which generates a converted signal by subjecting at least one detection signal of the detection signals to a conversion processing using a conversion data obtained from the one detection signal; and
a calculation section which calculates a position of the object based on the converted signal; and
a second detection sensor which detects a temperature,
wherein for a first detection signal of the detection signals, the conversion section carries out the conversion processing based on the first detection signal, and for a second detection signal, the conversion section prohibits the conversion processing based on the second detection signal, and
the second detection signal is a detection signal generated by the first detection sensor in a case where a difference between a temperature detected by the second detection sensor at a first timing and a temperature detected later at a second timing is greater than a predetermined value.

2. The position detection apparatus according to claim 1, further comprising a storage section which stores correction data for correcting the conversion data according to a temperature variation,
wherein in the case where the conversion processing based on the second detection signal on the second detection signal is prohibited, the conversion section calculates the conversion data corresponding to a greater temperature variation than the predetermined value based on the correction data and carries out the conversion processing using the conversion data on the second detection signal.

3. An optical apparatus comprising:
an optical system; and
the position detection apparatus according to claim 1 which detects a position of at least one optical element in the optical system.

4. An image-taking system which has a lens apparatus having a movable optical element and an image-taking apparatus on which the lens apparatus is mounted, comprising:
a first detection sensor which generates a plurality of detection signals according to movement of the optical element;
a conversion section which generates a converted signal by subjecting at least one detection signal of the detection signals to a conversion processing using a conversion data obtained from the one detection signal;
a calculation section which calculates a position of the optical element based on the converted signal; and
a second detection sensor which detects a temperature,
wherein for a first detection signal of the detection signals, the conversion section carries out the conversion processing based on the first detection signal, and for a second detection signal, the conversion section prohibits the conversion processing based on the second detection signal, and
the second detection signal is a detection signal generated by the first detection sensor in a case where a difference between a temperature detected by the second detection sensor at a first timing and a temperature detected later at a second timing is greater than a predetermined value.

5. A position detection method comprising:
a first step of generating a plurality of detection signals according to movement of an object;
a second step of generating a converted signal by subjecting at least one detection signal of the detection signals to a conversion processing using a conversion data obtained from the one detection signal;
a third step of calculating a position of the object based on the converted signal; and
a fourth step of detecting a temperature,
wherein in the second step, for a first detection signal of the detection signals, the conversion processing based on the first detection signal is carried out, and for a second detection signal, the conversion processing based on the second detection signal is prohibited, and
the second detection signal is a detection signal generated in the first step in a case where a difference between a temperature detected in the fourth step at a first timing and a temperature detected later at a second timing is greater than a predetermined value.

6. The position detection method according to claim 5, further comprising a fifth step of storing correction data for correcting the conversion data according to a temperature variation,
wherein in the second step, in the case where the conversion processing based on the second detection signal on the second detection signal is prohibited, the conversion data corresponding to a greater temperature variation than the predetermined value is calculated based on the correction data and the conversion processing using the conversion data is carried out on the second detection signal.

7. A program causing a computer to perform a position detection method, of detecting the position of an object, comprising:
a first step of generating a plurality of detection signals according to movement of an object;
a second step of generating a converted signal by subjecting at least one detection signal of the detection signals to a conversion processing using a conversion data obtained from the one detection signal;
a third step of calculating a position of the object based on the converted signal; and
a fourth step of detecting a temperature,
wherein in the second step, for a first detection signal of the detection signals, the conversion processing based on the first detection signal is carried out, and for a second detection signal, the conversion processing based on the second detection signal is prohibited, and
the second detection signal is a detection signal generated in the first step in a case where a difference between a temperature detected in the fourth step at a first timing and a temperature detected later at a second timing is greater than a predetermined value.

8. A position detection apparatus comprising;
a first detection sensor which outputs signal according to movement of an object;
a conversion section which subjects at least two detection data obtained from the signal of the first detection sensor to a conversion processing and outputs a converted signal;
a calculation section which calculates a position of the object based on the converted signal; and
a second detection sensor which detects a temperature,
wherein in a case where a difference between a temperature detected by the second detection sensor at a time when one detection data of at least two detection data is obtained and a temperature detected by the second detection sensor at a time when other detection data is obtained is greater than a predetermined temperature difference, the conversion section prohibits the conversion processing of the detection data.

9. The position detection apparatus according to claim 8,
further comprising a storage section which stores a correction data for correcting a converted data used in the conversion processing according to a temperature variation,
wherein in the case where the conversion processing of the detection data is prohibited, the conversion section calculates the converted data corresponding to a greater temperature variation than the predetermined temperature difference base on the correction data and performs the conversion processing to the detection data obtained from the signal of the first detection sensor using the converted data.

10. An optical apparatus comprising;
an optical system; and
the position detection apparatus according to claim 8 which detects a position of at least one optical element in the optical system.

11. A position detection method comprising;
a conversion step of subjecting at least two detection data obtained from a signal of a first detection sensor, which outputs the signal according to movement of an object, to a conversion processing and outputting a converted signal;
a calculation step of calculating a position of the object based on the converted signal; and
a temperature detection step of detecting a temperature,
wherein in the conversion step, in a case where a difference between a temperature detected in the temperature detection step at a time when one detection data of at least two detection data is obtained and a temperature detected in the temperature detection step at a time when other detection data is obtained is greater than a predetermined temperature difference, the conversion processing of the detection data is prohibited.

12. The position detection method according to claim 11,
further comprising a storage step of storing a correction data for correcting a converted data used in the conversion processing according to a temperature variation,
wherein in the conversion step, in the case where the conversion processing of the detection data is prohibited, the converted data corresponding to a greater temperature variation than the predetermined temperature difference base on the correction data is calculated and the conversion processing to the detection data obtained from the signal of the first detection sensor using the converted data is performed.

13. An image-taking apparatus which outputs a signal corresponding to an object light from an image-pickup device, and records the signal to a recording medium, comprising;
a first detection sensor which outputs a signal corresponding to movement of a lens;
a conversion section which subjects at least two detection data obtained from the signal of the first detection sensor to a conversion processing and outputs a converted signal;
a calculation section which calculates a position of the lens based on the converted signal; and
a second detection sensor which detects a temperature,
wherein in a case where a difference between a temperature detected by the second detection sensor at a time when one detection data of at least two detection data is obtained and a temperature detected by the second detection sensor at a time when other detection data is obtained is greater than a predetermined temperature difference, the conversion section prohibits the conversion processing of the detection data and the image-taking apparatus performs image-taking operation by taking the object light through the lens.

14. A program, in an image-taking apparatus which records a signal corresponding to an object light output from an image-pickup device to a recording medium and has a first detection sensor outputting a signal corresponding to movement of a lens and a second detection sensor detecting a temperature, controls an operations of the first and second detection sensor and a recording operation of the signal to the recording medium, comprising;
a conversion step of subjecting at least two detection data obtained from the signal of the first detection sensor to a conversion processing and outputting a converted signal;
a calculation step of calculating a position of the lens based on the converted signal; and
a temperature detection step of detecting a temperature by using the second detection sensor,
wherein in the conversion step, in a case where a difference between a temperature detected in the temperature detection step at a time when one detection data of at least two detection data is obtained and a temperature detected in the temperature detection step at a time when other detection data is obtained is greater than a predetermined temperature difference, the conversion processing of the detection data is prohibited.
